(19) United States
(12) Patent Application Publication
(10) Pub. No.: US 2007/0218315 A1
(43) Pub. Date: Sep. 20, 2007

(54) LAMINATE FOR HDD SUSPENSION AND PROCESS FOR PRODUCING THE SAME

(75) Inventors: Kazutoshi Taguchi, Chiba (JP); Kengo Takada, Chiba (JP)

Correspondence Address: DARBY & DARBY P.C., P.O. BOX 770, Church Street Station, New York, NY, 10008-0770, US

(73) Assignee: NIPPON STEEL CHEMICAL CO., LTD., Chiyoda-ku (JP)

(21) Appl. No.: 10/599,116

(22) PCT Filed: Mar. 31, 2005
(86) PCT No.: PCT/JP05/06273

§ 371 Date: Nov. 13, 2006

(30) Foreign Application Priority Data
Mar. 31, 2004 (JP) 2004-103167

(51) Int. Cl. G11B 21/21; G11B 5/48; B32B 15/08; G11B 5/60; G11B 21/16; H01B 13/00

(52) U.S. Cl. 428/800; 360/244.3; 216/13; 428/458; 29/603.03

(57) ABSTRACT

The subject of the present invention is to provide a laminate for an HDD suspension which has a thin conductive layer and is free from warpage (camber) or deformation and that in compliance with demands on an HDD suspension for realization of a high density and superfine wiring, ensures high reliability and high precision; and a production process for the same. There is provided a laminate for an HDD suspension containing a stainless layer, polyimide resin layer and conductive layer, wherein a thickness of the conductive layer is 10 μm or less, and in the production process, a laminate containing a stainless layer/polyimide resin layer/conductive layer is produced using the conductive layer having a thickness of larger than 10 μm, and then only the conductive layer is subjected to chemical etching to thereby reduce a thickness of the conductive layer to 10 μm or less.

### CROSS-REFERENCE TO PRIOR APPLICATIONS

This is a U.S. national phase application under 35 U.S.C. §371 of International Patent Application No. PCT/JP2005/006273, filed Mar. 31, 2005, and claims the benefit of Japanese Application No. 2004-103167, filed Mar. 31, 2004, both of which are incorporated by reference herein. The International Application was published in Japanese on Oct. 13, 2005 as International Publication No. WO 2005/096299 A1 under PCT Article 21(2).

### TECHNICAL FIELD

The present invention relates to a laminate used for an HDD suspension and a process for producing the same.

### BACKGROUND ART

A greater part of a suspension loaded in a hard disk drive (herein after referred to as HDD) has been replaced from a suspension of a wire type which has so far been used to a suspension of a wiring integration type which is stabilized in an ascending force and a position accuracy toward a disk which is a storage medium as a higher capacity is expedited. Among the above wiring integration types, available is a type called a TSA (trace suspension assembly) method in which a laminate of a stainless foil-polyimide resin-copper foil is processed into a prescribed form by etching processing.

A TSA system suspension makes it possible to readily form a flying lead by laminating an alloyed copper foil having a high strength, and it is widely used because of a high freedom in shape processing, a relatively low cost and a good dimensional accuracy. In this regard, a laminate for an HDD suspension obtained by forming a polyimide base resin layer and a conductive layer in order on a stainless substrate has already been disclosed (refer to, for example, WO 98/08216). Described therein are those in which a linear expansion coefficient of the polyimide resin layer and an adhesive force between the polyimide resin layer and the conductive layer are prescribed in order to prepare a laminate suited to a laminate for an HDD suspension.

### SUMMARY OF THE INVENTION

However, the existing situation is that a thin copper foil of 10 μm or less has not yet been put into practical use because of the problems of a handling property in a copper foil production step and a laminate production step and cost. Usually, it is produced by forming an insulating layer containing a polyimide resin on a stainless foil and then laminating later a commercial copper foil as a conductive layer by heating and pressing. Accordingly, a thin conductive layer of 10 μm or less has difficulty in the handling property and the cost each described above, and the existing situation is that a laminate for an HDD suspension having a thin conductive layer is not materialized.

In light of the above existing situations, an object of the present invention is to provide a laminate for an HDD suspension which has a thin conductive layer and is free of warpage (camber) and deformation and which meets requirement for an HDD suspension provided with a high density and superfine wiring and has a high reliability and a high precision and a production process for the same.

Intensive investigations repeated by the present inventors in order to solve the above problems have resulted in coming to complete the present invention by obtaining a laminate and then subjecting a conductive layer to chemical etching to reduce a conductor thickness.

That is, the present invention relates to a laminate for an HDD suspension containing a stainless layer, polyimide resin layer, and conductive layer, wherein a thickness of the conductive layer is 10 μm or less.

Also, it relates to the laminate for an HDD suspension, wherein the conductive layer is an alloyed copper foil having a strength of 500 MPa or more and an electric conductivity of 65% or more.

Further, the present invention relates to a production process of a laminate for an HDD suspension, wherein a laminate containing a stainless layer, polyimide resin layer, and conductive layer is produced using the conductive layer having a thickness of larger than 10 μm, and then only the conductive layer is subjected to chemical etching to thereby reduce a thickness of the conductive layer to 10 μm or less.

Also, it is the desirable embodiment that the conductive layer in the production process of the present invention is an alloyed copper foil having a strength of 500 MPa or more and an electric conductivity of 65% or more and that the laminate after subjected to chemical etching is subjected to supersonic treatment in an alkaline solution.

According to the present invention, a laminate for an HDD suspension which has a thin conductive layer and which is free from warpage (camber) and deformation, and therefore capable of being prepared is an HDD suspension which meets requirement for an HDD suspension provided with a high density and superfine wiring and which has a high reliability and shows a high precision.

Further, capable of being provided are a laminate for a suspension which enhances a freedom of a spring characteristic required for an HDD suspension and has a conductive layer having a strength sufficient for forming a stable flying lead and which provides a substrate material for a suspension corresponding to processing of a fine wiring of a high level and can achieve an HDD of a higher capacity than ever before without damaging a conventional production process ability and a production process for the same.

### DETAILED DESCRIPTION OF THE INVENTION

The laminate for an HDD suspension according to the present invention (hereinafter referred to as the laminate) contains a stainless layer/polyimide resin layer/conductive layer. The stainless layer in the present invention shall not specifically be restricted, and it is preferably a stainless foil having a high elasticity and a high strength such as SUS304 from the viewpoints of a spring characteristic and a dimensional stability, particularly preferably SUS304 subjected to annealing treatment at a temperature of 300° C. or higher. The stainless layer used has a thickness falling in a range of preferably 10 to 50 μm, particularly preferably 18 to 30 μm. If a thickness of the stainless layer is less than 10 μm, a spring property of sufficiently controlling a lifting amount of a slider is likely to be unable to be secured. On the other hand, if it exceeds 50 μm, the rigidity is increased too much to make it difficult to reduce lifting of the slider loaded.

The polyimide resin layer in the laminate may advisably be a resin having an imide bond in a skeleton thereof such as polyimide, polyamide, polyetherimide and the like. The polyimide resin layer may contain only a single layer, but it preferably contains plural polyimide resin layers. When the polyimide resin layer contains plural polyimide resin layers, the resin showing a good adhesive property to the conductive layer or the stainless layer is preferably used for the polyimide resin layer which is brought into contact with the conductive layer or the stainless layer. The polyimide resin showing a good adhesive property includes those having a glass transition temperature of 300° C. or lower.

The resin in which a dimensional change rate to a change in temperature, that is, a linear expansion coefficient is 30×10⁻⁶/° C. or less is preferably used for the intermediate layer which is not brought into contact with the conductive layer and the stainless layer from the viewpoint of a dimensional stability when the HDD suspension is prepared. When the polyimide resin layer is formed by plural layers of three or more layers, a ratio of the total thickness (tₐ) of both outermost layers to the thickness (t_{b}) of the other layers (intermediate layers) falls advantageously in a range of tₐ/t_{b}=0.1 to 0.5.

The conductive layer in the present invention is formed preferably from an alloyed copper foil. In this case, the alloyed copper foil indicates an alloy foil which contains copper as an essential component and which contains a different kind of at least one element other than copper such as chromium, zirconium, nickel, silicon, zinc, beryllium and the like, and it means an alloy foil having a copper content of 90% by weight or more.

In the present invention, the alloyed copper foil having a copper content of 95% by weight or more is preferably used. A thickness of the alloyed copper foil forming the conductive layer has to be 10 μm or less and falls in a range of preferably 9 μm or less, particularly preferably 8 μm or less. If it exceeds 10 μm, an elasticity of the copper foil exerts an effect on lifting of the slider to a large extent, and it is not preferred from the viewpoints of the fine position accuracy and fine wiring processing of the conductor.

In the laminate of the present invention, a thickness of the conductive layer has to be 10 μm or less, and a tensile strength of the copper foil before being laminated is preferably 500 MPa or more and, though an upper limit thereof shall not specifically be restricted, 1000 MPa or less. The electric conductivity is particularly preferably 65% or more. If a tensile strength of the conductive layer is less than 500 MPa, a sufficient copper foil strength is not obtained when forming a flying lead, and problems such as breaking are liable to be brought about. If the electric conductivity is less than 65%, noise generated from a resistive element of the copper foil is diffused in the form of heat to make it difficult to control the impedance, and the transmission rate is not satisfactory. The values of the tensile strength and the electric conductivity in the present invention are measured by methods described in examples shown later.

In the present invention, the conductive layer of the laminate (hereinafter referred to as the pre-thin-walled laminate) containing a copper foil having a thickness of larger than 10 μm as a conductive layer is subjected to chemical etching to a prescribed thickness, whereby obtained is the laminate (herein after referred to as the thin-walled laminate) of the present invention containing the conductive layer having a thickness of 10 μm or less. The stainless layer is chemically inactive to an etching liquid of copper as compared with the conductive layer containing alloyed copper, and an etching speed thereof is as small as negligible. Accordingly, substantially only the conductive layer is etched by chemical etching, and the stainless layer is not changed in thickness. Thus, it is a method suited for producing the thin-walled laminate in the present invention.

In producing the pre-thin-walled laminate, a publicly known method can be applied. Preferred is, for example, a method in which a polyimide resin solution or a polyimide precursor resin solution is applied on the stainless layer and in which the solvent is removed to some extent by heating and then imidation is expedited by heat treatment. After forming the polyimide resin layer in the manner described above, a copper foil or an alloyed copper foil having a thickness of larger than 10 μm, a tensile strength of 500 MPa or more and an electric conductivity of 65% or more is superposed on the above polyimide resin layer, and it is heated and pressed at a temperature of 280° C. or higher, whereby the laminate containing the stainless layer/polyimide resin layer/conductive layer can be prepared.

Pressing is preferably carried out on the conditions of a range of 1 to 50 MPa and 5 to 30 minutes. Further, pressing is preferably carried out at a hot press temperature falling in a range of 300 to 400° C. If the hot pressing conditions are deviated from the ranges described above, deformation such as camber and a reduction in an unpeeling strength are caused in the laminate described above, and therefore it is not preferred.

Publicly known methods can be used for the chemical etching of the conductive layer. Capable of being suitably used is, for example, a method in which it is dipped in an etching solution of a sulfuric acid-hydrogen peroxide base, a ferric chloride-hydrochloric acid base or a cupric chloride-hydrochloric acid base or sprayed thereon with it. According to the above chemical etching, the stainless foil is not etched, and only the copper alloy can homogeneously be etched.

Alloy components other than copper remain after etching, though it is a phenomenon inherent to etching of an alloyed copper foil, in a certain case in the form of particles which are less liable to be etched. It is effective to carry out supersonic treatment in an alkaline solution to remove the particles as a counter measure thereof. The thin-walled laminate obtained by the above method has small camber and is flat on the surface of the conductive layer, and therefore it can suitably be used for an HDD suspension.

### EXAMPLES

The present invention shall specifically be explained below with reference to examples, but the present invention shall by no means be restricted by these examples. Various physical properties in the examples were measured by the following methods.

<Measurement of Electric Conductivity>

A copper foil was degreased with acetone, and then a roughening treatment part was removed by a soft etching solution containing a mixed acid of sulfuric acid 10% and hydrogen peroxide 5%. Then, a strip-shaped test piece having a length of 300 mm and a width of 10mm was cut out and used for measuring an electric conductivity in a constant temperature room of 20° C. by means of a precession class current potentiometer for low voltage manufactured by Yokokawa Hokushin Electric Co., Ltd.

<Measurement of Tensile Strength of Copper Foil>

A strip-shaped test piece having a width of 12.7 mm and a length of 254 mm was cut out and used for carrying out measurement at a crosshead speed of 50 mm/minute and a chuck-to-chuck distance of 50.8 mm by means of a tensile testing machine (Strograph R1, manufactured by Toyo Seiki Co., Ltd.) to determine displacement (elongation) during the tensile test, and a 0.2% proof stress was calculated from an SS curve.

<Measurement of Thickness>

A strip-shaped test piece having a width of 10 mm and a length of 305 mm was cut out to measure thicknesses in 30 points at an interval of 10 mm in a longitudinal direction by means of a dial gauge (manufactured by Mitutoyo Co., Ltd.). Then, the copper part was etched to measure a thickness of a two-layer matter of a stainless layer/polyimide layer in the same manner. A thickness of the copper foil was calculated from a difference between two thicknesses.

<Measurement of Roughness of Copper Foil>

A copper foil surface was measured at 2000 magnifications in 140 μm in a longitudinal direction by means of a deep shape measuring microscope (VK-8500, manufactured by KEYENCE CORPORATION).

<Measurement of Warpage>

A disk having a diameter of 65 mm was produced by subjecting the laminate to circuit processing, and a part in which camber (disk curling) was the largest when put on a desk was measured by means of a caliper square. The following brevity codes are used in the reference examples and the examples.
BPDA: 3,3′,4,4′-biphenyltetracarboxylic dianhydride
DADMB: 4,4′-diamino-2,2′-dimethylbiphenyl
BAPP: 2,2′-bis[4-(4-aminophenoxy)phenyl]propane
DMAc: N,N-dimethylacetamide

### Synthetic Example 1

DADMB of 9.0 mole was weighed and dissolved in 25.5 kg of a solvent DMAc while stirring in a planetary mixer of 40 L. Then, 8.9 mole of BPDA was added thereto and continued to be stirred at room temperature for 3 hours to carry out polymerization reaction, whereby a viscous solution of a polyimide precursor A was obtained.

### Synthetic Example 2

DADMB of 6.3 mole was weighed and dissolved in 25.5 kg of a solvent DMAc while stirring in the planetary mixer of 40 L. Then, 6.4 mole of BPDA was added thereto and continued to be stirred at room temperature for 3 hours to carry out polymerization reaction, whereby a viscous solution of a polyimide precursor B was obtained.

### Reference Example 1 (Preparation 1 of Laminate before Etching)

A solution of the polyimide precursor B obtained in Synthetic Example 2 was applied on a stainless foil (SUS304, tension annealing-treated product, thickness 20 μm, manufactured by Nippon Steel Corporation) so that a thickness after curing was 1 μm, and it was dried at 110° C. for 3 minutes. Then, a solution of the polyimide precursor A obtained in Synthetic Example 1 was applied thereon so that a thickness after curing was 7.5 μm, and it was dried at 110° C. for 10 minutes. Further, a solution of the polyimide precursor B obtained in Synthetic Example 2 was applied thereon so that a thickness after curing was 1.5 μm, and it was dried at 110° C. for 3 minutes. Then, imidation was completed in a range of 130 to 360° C. at several stages by stepwise heat treatment for each 3 minutes to obtain a laminate having the polyimide resin layer having a thickness of 10 μm on the stainless. The polyimide resin layer of the first layer was the same as the polyimide resin layer of the third layer.

Next, a rolled copper foil manufactured by Japan Energy Co., Ltd. (NK-120, copper foil thickness: 12 μm, strength: 556 MPa, electric conductivity: 79%) was superposed thereon and heated and pressed by means of a vacuum pressing machine on the conditions of a surface pressure of 15 MPa, a temperature of 320° C. and a press time of 20 minutes to obtain a laminate (pre-thin-walled laminate A) containing a conductor having a thickness of 12 μm.

### Reference Example 2 (Preparation 2 of Laminate before Etching)

A laminate (pre-thin-walled laminate B) containing a conductor having a thickness of 18 μm was obtained in the same manner as in Reference Example 1, except that used was a rolled copper foil manufactured by Japan Energy Co., Ltd. (NK-120, copper foil thickness: 18 μm, strength: 76 MPa, electric conductivity: 58.4%)

### Example 1

The pre-thin-walled laminate A produced in Reference Example 1 was cut into 305 mm×340 mm and etched. Etching was carried out at 35° C. for 33.8 seconds using an etching solution (1) of a hydrogen peroxide/sulfuric acid base (H₂O₂=6 vol %, H₂SO₄=10 vol %) and then at 35° C. for 4.2 seconds using an etching solution (2) of a hydrogen peroxide/sulfuric acid base (H₂O₂=10 vol %, H₂SO₄=20 vol %). Further, the laminate was dipped in a 3 wt % sodium hydroxide aqueous solution and subjected to supersonic treatment at room temperature for one minute to obtain a thin-walled laminate. The laminate thus obtained had a thickness of 10.0 μm in a conductive layer, Ra of 0.09, Rz of 0.42 and a camber (disk curl) of 1.24.

### Examples 2 to 7

Etching was carried out in the same procedure as in Example 1 changing treating time so that a thickness of the conductive layer after etching was changed. The results thereof are shown in the following Table 1.

TABLE 1

| | Example | | | | | | |
|---|---|---|---|---|---|---|---|
| | 1 | 2 | 3 | 4 | 5 | 6 | 7 |
| Etching solution (1) | 14.7 | 25.0 | 33.8 | 42.2 | 50.6 | 58.7 | 66.1 |
| treating time | | | | | | | |
| (second) | | | | | | | |
| Measured thickness | 10.0 | 9.3 | 8.3 | 7.4 | 6.3 | 5.5 | 4.5 |
| (μm) | | | | | | | |
| Ra (μm) | 0.09 | 0.10 | 0.09 | 0.08 | 0.12 | 0.12 | 0.10 |
| Rz (μm) | 0.42 | 0.39 | 0.40 | 0.41 | 0.44 | 0.42 | 0.41 |
| Disk curl (mm) | 1.24 | 0.82 | 0.89 | 1.57 | 1.03 | 1.33 | 1.28 |

### Examples 8 to 14

Etching was carried out in the same procedure as in Example 1 changing treating time so that a thickness of the conductive layer after etching was changed, except that the pre-thin-walled laminate B was used. The results thereof are shown in the following Table 2.

TABLE 2

| | Example | | | | | | |
|---|---|---|---|---|---|---|---|
| | 8 | 9 | 10 | 11 | 12 | 13 | 14 |
| Etching | 66.9 | 75.6 | 83.9 | 92.7 | 100.6 | 108.9 | 117. 6 |
| solution (2) | | | | | | | |
| treating | | | | | | | |
| time (second) | | | | | | | |
| Measured | 10.0 | 9.4 | 8.4 | 7.4 | 6.5 | 5.4 | 4.5 |
| thickness | | | | | | | |
| (μm) | | | | | | | |
| Ra (μm) | 0.13 | 0.12 | 0.13 | 0.10 | 0.12 | 0.09 | 0.13 |
| Rz (μm) | 0.45 | 0.43 | 0.43 | 0.39 | 0.44 | 0.374 | 0.41 |
| Disk curl | 1.16 | 0.93 | 1.74 | 0.88 | 1.53 | 1.27 | 0.95 |
| (mm) | | | | | | | |

### INDUSTRIAL APPLICABILITY

The laminate for an HDD suspension and the production process for the same according to the present invention are a laminate for an HDD suspension which has a thin conductive layer and which is free from warpage and deformation and a production process of a laminate for an HDD suspension which meets requirement for an HDD suspension provided with a high density and superfine wiring and which has a high reliability and shows a high precision. The conductive layer is subjected to chemical etching after obtaining the laminate to reduce a thickness of the conductor, whereby the laminate for an HDD suspension which has a thickness of 10 μm or less in a conductive layer and which has a high industrial applicability is obtained.

1. A laminate for an HDD suspension comprising a stainless layer, a polyimide resin layer, and a conductive layer, wherein a thickness of the conductive layer is 10 μm or less, and a surface roughness (Ra) of the conductive layer is 0.15 μm or less.

2. The laminate for an HDD suspension as described in claim 1, wherein the conductive layer is an alloyed copper foil having a strength of 500 MPa or more and an electric conductivity of 65% or more.

3. (canceled)

4. A production process of a laminate for an HDD suspension, wherein a laminate comprising a stainless layer, a polyimide resin layer, and a conductive layer is produced by using a conductive layer having a thickness of larger than 10 μm, and thereafter only the conductive layer is subjected to chemical etching to thereby reduce a thickness of the conductive layer to 10 μm or less.

5. The production process of a laminate for an HDD suspension as described in claim 4, wherein the conductive layer is an alloyed copper foil having a strength of 500 MPa or more and an electric conductivity of 65% or more.

6. The production process of a laminate for an HDD suspension as described in claim 4, wherein the laminate after subjected to chemical etching is subjected to supersonic treatment in an alkaline solution.

7. The production process of a laminate for an HDD suspension as described in claim 5, wherein the laminate after subjected to chemical etching is subjected to supersonic treatment in an alkaline solution.

8. The production process of a laminate for an HDD suspension as described in claim 4, wherein the conductive layer after subjected to chemical etching has a surface roughness (Ra) of 0.15 μm or less.

9. The production process of a laminate for an HDD suspension as described in claim 5, wherein the conductive layer after subjected to chemical etching has a surface roughness (Ra) of 0.15 μm or less.

10. The production process of a laminate for an HDD suspension as described in claim 6, wherein the conductive layer after subjected to chemical etching has a surface roughness (Ra) of 0.15 μm or less.
